(19) United States
(12) Patent Application Publication
(10) Pub. No.: US 2026/0141593 A1
(43) Pub. Date: May 21, 2026

(54) FINE-GRAINED IMAGE GENERATION USING GENERATIVE ARTIFICIAL INTELLIGENCE AND BRAND-ALIGNED SOURCE IMAGES

(71) Applicant: Adobe Inc., San Jose, CA (US)

(72) Inventors: Dhwanit AGARWAL, San Jose, CA (US); Shradha AGRAWAL, San Jose, CA (US); Ambareesh REVANUR, San Jose, CA (US)

(21) Appl. No.: 18/952,893

(22) Filed: Nov. 19, 2024

(51) Int. Cl. G06T 11/60

(52) U.S. Cl. CPC G06T 11/60; G06T 2200/24

(57) ABSTRACT

Some aspects relate to technologies providing a framework for generating brand-aligned images using generative artificial intelligent (AI) models. In accordance with some aspects, brand-aligned reference images are received and image elements of those images are identified. Style and structure data of each of those brand-aligned image elements is generated and those layout masks are received that indicate where, in an output image, those image elements are to be placed. A generative AI model is used to generate an output image that locates the reference image elements according to the layout masks while using the style and structure data.

### BACKGROUND

Creating brand-aligned content using existing images involves adapting elements of those existing image assets to generate new image assets. This adaptation of the elements of those existing images poses various challenges, including determining the style or structure of those images and incorporating that style or structure into new images. One particular challenge is maintaining fine-grained control of the layout of the elements of the existing images while incorporating the style or structure. The challenges are compounded when, for example, elements from multiple images are to be combined to generate a new image that maintains style and structure while enabling fine-grained layout control.

### SUMMARY

Some aspects of the present technology relate to, among other things, systems and methods to use generative artificial intelligence (“AI”) models that use multiple images to generate an output image that incorporates style and structure of reference images into a base image, while enabling fine-grained layout. In some aspects, the reference images include previously generated brand-aligned content that is used to generate new images that conform to the style and structure of the brand-aligned content while incorporating elements of the base image. In accordance with some aspects of the technology described herein, reference images are used to perform multi-image conditioned inpainting and outpainting, using shared self-attention in a single forward pass to generate a new brand-aligned image that is built from elements of the base image. In some aspects, reference masks are used in the self-attention steps performed during image generation. In some aspects, fine-grained layout control (e.g., the placement of the inpainted and outpainted elements of the reference images) is performed using query-mask guided adjustments in the attention similarity matrix during image generation.

In accordance with aspects of the technology described herein, a base image is obtained, which will be used as the basis for an output image. In accordance with aspects of the technology described herein, one or more reference images are obtained. The reference images can, for example, include elements that are to be combined with the base image to generate a new image using generative AI models. In accordance with aspects of the technology described herein, style and structure of the reference images are determined using various techniques such as image segmentation models. Determining both the style and structure of the elements from the reference images preserves the brand-aligned elements. In accordance with aspects of the technology described herein, a layout of how the elements of the reference images will be placed, relative to the base image, is determined. In some aspects, this layout is determined using layout masks, which are to specify locations in the base image where the elements of the reference images are to be placed. In accordance with aspects of the technology described herein, an output image is generated using generative AI models. Given the base image, the reference images, and the layout masks, an image generation model generates the new brand-aligned image that incorporates the style and structure of the reference images into the base image. The layout masks enable fine-grained layout (e.g., precise placement) of the reference image elements by the image generation model using inpainting of the reference image elements into the base image.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system for performing multi-image based fine-grained image generation, in accordance with implementations of the present disclosure;

FIG. 2 is a flow diagram showing an example process for performing multi-image based fine-grained image generation, in accordance with some implementations of the present disclosure;

FIG. 3 is a block diagram showing an example image asset component, in accordance with some implementations of the present disclosure;

FIG. 4 is a block diagram showing an exemplary data flow of a system used to perform multi-image based fine-grained image generation, in accordance with some implementations of the present disclosure;

FIGS. 5A and 5B illustrate an exemplary shared self-attention computation, in accordance with some implementations of the present disclosure;

FIGS. 6A and 6B illustrate an exemplary shared self-attention computation using masks for fine-grained shared self-attention, in accordance with some implementations of the present disclosure;

FIGS. 7A and 7B illustrate an exemplary shared self-attention computation using layout masks and fine-grained shared self-attention, in accordance with some implementations of the present disclosure;

FIG. 8 is a block diagram showing an exemplary architecture of a system used to perform multi-image based fine-grained image generation, in accordance with some implementations of the present disclosure; and

FIG. 9 is a block diagram of an exemplary computing environment suitable for use in implementations of the present disclosure.

### DETAILED DESCRIPTION

Various terms are used throughout this description. Descriptions of some terms are included below to provide a clearer understanding of the ideas disclosed herein. As used herein, an “image” is a digital image or a digital video (e.g., a plurality of images). In some instances, an image comprises pixel values based on a raster image file or a vector image file. In some instances, an image is a photograph, a drawing, a computer-generated image, or a combination of these and/or other such image types.

As used herein, a “base image” is a source image that is used as the basis for a generated image. In some instances, a base image includes foreground and/or background elements that determine the structure of an image generated using an image generation model. In some instances, foreground elements of a base image are preserved (e.g., remain unchanged) during image generation. In some instances, background elements of a base image are preserved during image generation. In some instances at least some foreground elements of a base image are removed and/or replaced during image generation. In some instances, some or all background elements of a base image are removed and/or replaced during image generation.

As used herein, a “reference image” is an image that includes elements that will be added to (e.g., inpainted into) a base image during image generation. In some instances, a reference image includes elements that will not be added to a base image during image generation. In some instances, a reference image is one of a plurality of reference images used during image generation. In some instances, a reference image includes brand-aligned content, as described herein.

As used herein, an “element” of a reference image is a discernable object that is illustrated in the reference image. In some instances, an element of a reference image is a describable object (e.g., a tree, an airplane, etc.). In some instances, a reference image comprises a plurality of elements.

As used herein, the “style” of a reference image is the visual elements of the reference image (e.g., color, line style, color palette, type of image, etc.). In some instances, the style of a reference image refers to the style of an element of a reference image and, in such instances, a reference image may comprise a plurality of styles. In some instances, the style of a reference image is an overall style of the reference image (e.g., “cartoon,” “realistic,” “bold,” “dark,” etc.).

As used herein, the “structure” of a reference image is the shape of an image (e.g., height and width of the image, proportions, relative proportions, etc.). In some instances, the structure of a reference image refers to the structure of an element of a reference image and, in such instances, a reference image may comprise a plurality of structures. In some instances, the structure of a reference image is an overall structure of the reference image. In some instances, a reference image has both a style and a structure. In some instances, each element of a reference image has both a style and a structure. In some instances, a reference image may have only a style or only a structure. In some instances, an element of a reference image may have only a style or only a structure.

As used herein, “fine-grained layout” or “fine-grained layout control” refers to the ability to accurately select elements from reference images and insert them at specified locations for use in image generation.

As used herein, a “layout mask” is an indication of an area within a base image where elements from reference images are to be placed during image generation. In some instances, a layout mask is a precise location. In some instances, a layout mask is an approximate location. In some instances, a layout mask is an image where, for example, pixels of a certain color (e.g., black pixels, white pixels, etc.) indicate where an element of a reference image is to be placed. In some instances, a layout mask is a specified location (e.g., “from pixel x1, y1 to pixel x2, y2”). In some instances, a layout mask is an approximate location (e.g., “in the upper right corner”). In some instances, a layout mask is also referred to as a “query layout mask.” In some instances, where a layout mask is a precision location, a segmentation model (described herein) can be used to determine locations within an output image at which reference image elements are to be placed during image generation. In some instances, where a layout mask is an approximate location, a segmentation model may not be used to determine locations within an output image at which reference image elements are to be placed during image generation.

As used herein, a “brand-aligned content” includes images that comprise brand specific elements that can be used in image generation. In some instances, brand-aligned content refers more generally to images that comprise elements with style and/or structure that is to be preserved during image generation.

As used herein, “inpainting” of an image is the addition of reference image elements during image generation. In some instances, inpainting generates image areas in the foreground of the generated image.

As used herein, “outpainting” of an image is addition of elements, either from reference images or automatically generated, in the background of a generated image. As used herein, inpainting and outpainting are used for the sake of clarity and, in some instances, they are the same operation so that, for example, foreground elements can be outpainted and background elements can be inpainted.

As used herein, “shared self-attention” is a concept of deep-learning (DL) that allows a neural network model to have access to all elements (e.g., to the entirety of the image) and to share the weights across all transform layers.

As used herein, an “untrained model” is a generative AI model that has not been trained using specific content and is, instead, trained using a general image corpus.

As used herein, a “reference mask” is a mask of a reference image that indicates where, in the reference image, a reference image element is located. In some instances, a reference mask is an image. In some instances, a reference mask is a description of a location within a reference image.

As used herein, an “attention similarity matrix” generally refers to a normalized probability matrix that gives a representation of which elements of an image attend to which elements (e.g., in a final image). An attention similarity matrix can be used to determine the layout of different elements and, in some aspects, manipulating this matrix can control which elements appear where in the final image.

As used herein, “image generation” generally refers to the process of generating an image using a generative AI model. In some instances, the generative AI model is referred to as an “image generation model.” In some instances, image generation uses a diffusion model to noise and denoise an image (e.g., a base image and/or or a reference image) to generate a variant image using multiple reference images and that incorporates style and structure of reference images into a base image.

### Overview

Generating brand-aligned images using generative artificial intelligence (“AI”) models is challenging for many reasons. A first challenge is that brand-aligned content can be very specific, and can include specific colors, shapes, color palettes, logos, characters, and many other such elements. Each of these elements must be retained during image generation in order for the generated image to be recognizable by consumers and other users as being associated with the brand. Even small variations can be jarring when, for example, a brand is well-known and the colors, shapes, color palettes, logos, characters, and other such elements have been used in previous marketing materials. Manually generating such content can be very time consuming, particularly when a large number of image variants are needed (e.g., for a marketing campaign), and using generative AI models can greatly accelerate the workflow of generating such content.

Generating images using generative AI models typically starts with a query or prompt such as “generate an image of a person standing in a field with mountains in the background and clouds in the sky.” The generative AI model is trained to generate such images, generally using a large corpus of images. In some aspects, a generative AI model is a latent diffusion model that is trained using the objective of removing successive applications of Gaussian noise on the training image corpus. A latent diffusion model performs diffusion modeling in latent space, by allowing self-attention conditioning (e.g., coherence within the image itself) and cross-attention conditioning (e.g., coherence with the text of the prompt). The generative AI model takes the prompt and generates the image according to the prompt.

Generating brand-aligned images using generative AI models presents several additional challenges. One such challenge is that a prompt to generate an image that mixes generated image elements with brand-aligned content can alter the style, structure, or location of the brand-aligned content during image generation. For example, a prompt to “generate an image of a person standing in a field with mountains in the background and clouds in the sky” that includes brand-aligned trees from a reference image might place the trees in unusual locations or might change the style of the trees or might change the structure of the trees. One conventional solution to this is to have a generative AI model that is specifically trained to use the brand-aligned content (e.g., is trained using brand-aligned images), but such training is generally insufficient. A typical generative AI model can be trained with millions of images. Training using only brand-aligned content would yield a poor image generation model and training that is augmented with brand-aligned content would not preserve the details of the brand-aligned content.

One conventional approach is to add reference image inputs to the image generation process so that, for example, the prompt could be “generate an image of a person standing in a field with mountains in the background and clouds in the sky and add these trees and this airplane from these reference images.” However, this approach can be prone to subtle errors in selecting and using the reference image elements. For example, the trees in the reference image could be part of a larger image (e.g., from previously generated marketing elements) that includes other elements that are not brand-aligned and that would not be relevant to the new content. Inpainting these other elements because of a lack of fine-grained control of the element selection can generate images that are less closely brand-aligned. Similarly, this approach can be prone to subtle errors that might alter small details of the reference image elements or not allow precise placement of those elements within a base image. Subtle alteration of important style and structure aspects of brand-aligned elements can be jarring to persons (e.g., consumers) that are familiar with that brand. Similarly, imprecise or imperfect placement of such brand-aligned elements can be confusing (e.g., if a tree is not located precisely on the “ground”).

Further, such conventional approaches can consume unnecessary computing resources. For example, the training that uses only brand-aligned content and that results in a poor image generation model would require considerable regeneration of the resulting images, with more specific and/or detailed prompts. Similarly, training that is augmented with brand-aligned content may not preserve the details of the brand-aligned content, also requiring regeneration of the resulting images, with more specific and/or detailed prompts. In both of these cases, several iterations of the image generation process may be required to obtain a correct results, each of which would require using additional computing resources. Similarly, adding reference image inputs to the image generation process can also require multiple regenerations where, for example, a prompt would need to be fine-tuned to fix style, structure, or layout errors. Aspects of the technology described herein provide a number of improvements over existing technologies that avoid costly regeneration of generated images, thus more efficiently using computing resources.

Aspects of the technology described herein use generative AI models to generate variant images that use a base image (e.g., a source image) and reference images (e.g., that include brand-aligned elements) while enabling fine-grained selection and precise layout. In some aspects, the reference images include previously generated brand-aligned content that is used to generate new images that conform to the style and structure of the brand-aligned content while incorporating elements of the base image. In accordance with some aspects of the technology described herein, reference images are used to perform multi-image conditioned inpainting and outpainting, using shared self-attention in a single forward pass to generate a new brand-aligned image that is built from elements of the base image. In some aspects, reference masks are used in the self-attention steps performed during image generation. In some aspects, fine-grained layout control (e.g., the placement of the inpainted and outpainted elements of the reference images) is performed using query-mask guided adjustments in the attention similarity matrix during image generation.

In accordance with some aspects, a prompt such as “generate an image of a person standing in a field with mountains in the background and clouds in the sky and add these trees and this airplane from these reference images” can be used by a generative AI model (e.g., an off-the-shelf model that is not specifically trained using the brand-aligned content) to generate a variant image that has the specified elements, including the style and structure of the elements from the reference images, does not include extraneous elements from the reference images, and that has the reference elements well-placed within the base image.

In accordance with aspects of the technology described herein, a base image is obtained, which will be used as the basis for an output image. The base image can, for example, include elements that are to be incorporated into an AI-generated image. In some aspects, the base image includes foreground elements and background elements that serve as the basis for generated images. As an illustrative example, a base image can be an image of a person standing in a field, with mountains in the background and clouds in the sky. In some aspects, the base image is a photograph. In some aspects, the base image is an illustration. In some aspects, the base image is computer generated (e.g., using a graphics engine or game engine). In some aspects, the base image is a video (e.g., a plurality of these and/or other types of images). In some aspects, the base image includes a combination of these types of content (e.g., includes photographs, illustrations, and/or computer generated images).

In accordance with aspects of the technology described herein, one or more reference images are obtained. The reference images can, for example, include elements that are to be combined with the base image to generate a new image using generative AI models. In some aspects, the reference images can include foreground elements, background elements, etc. In some aspects, the reference images include brand-aligned content that, for example, include marketing elements related to a particular brand. As used herein, brand-aligned images are also referred to as images in a “brand kit,” where such images have already been approved for use in, for example, marketing campaigns. In some aspects, brand-aligned content can include images (e.g., such as those described above) comprising logos, characters, mascots, colors, shapes, and/or other such assets. In some aspects, where a base image is a video (e.g., a plurality of frames), brand-aligned content can include animations and/or videos, which can include sounds or other such temporal elements.

Continuing with the example above, where the base image is an image of a person standing in a field, with mountains in the background and clouds in the sky, a first reference image can include some trees (e.g., that are recognizable brand elements) that are to be added to the base image and a second reference image can include a brand-aligned airplane that is also to be added to the base image, thereby creating a brand-aligned image of a person standing in a field amongst the brand-aligned trees, with the mountains in the background, and the brand-aligned airplane flying amongst the clouds in the sky. In some aspects, design elements from multiple reference images are to be incorporated into the base image to generate a new image.

In some aspects, the reference images can include multiple assets, some of which will be used to generate the output image and some of which will not be used to generate the output image. For example, a reference image that includes a brand-aligned airplane parked at an airport with a hangar and passengers can be used as a reference image just for the airplane and not the other elements of the image. In some aspects, a base image can be used as a reference image, a reference image can be used as a base image, and/or an output image can be used as a new base image and/or a new reference image. In some aspects, elements from a reference image are selected using systems and methods such as those described below.

As may be contemplated, the distinctions used herein for base images and reference images are to aid in discussion of the technology described herein. For example, in an aspect where a user has a picture of a product positioned on a table and desires to maintain the product placement on the table, but would like the table to look different (e.g., so that, for example, the product stands out better). In this example, the picture of the product sitting on the first table can be considered as the base image, and a picture of a different table can be considered as a reference image. Conversely, the picture of the different table could also be considered as the base image (including, for example, the room where the different table is located as the background of the new, generated image) and a picture of the product could be used as the reference image. In some aspects, as described herein, portions of an image or images to be generated are not specified and are, instead, generated by an image generation model such as those described herein.

In accordance with aspects of the technology described herein, style and structure of the reference images are determined using various techniques such as image segmentation models. As used herein, style and structure of a reference image are two interrelated aspects of elements of the reference images. For example, the brand-aligned tree described above can have brown stems, green leaves, and white flowers in a “cartoon” style (e.g., with bold lines, bright colors, and minimal shading) with a structure that is tall and thin, with dense leaves, but sparse flowers. In another example, the brand-aligned airplane can have a logo on the tail, a certain color palette, and a “cartoon” style and a structure that includes, for example, the size of the wings as compared to the size of the overall plane. Determining both the style and structure of the elements from the reference images preserves the brand-aligned elements. In some aspects, the style and structure of the elements of the reference images are determined automatically so that, for example, a user can specify “use the tree from this reference image” and software (e.g., a segment anything model or “SAM”) can locate the tree in the reference image and determine the style and structure accordingly, as described herein.

In accordance with aspects of the technology described herein, a layout of how the elements of the reference images will be placed, relative to the base image, is determined. In some aspects, this layout is determined using layout masks, which are to specify locations in the base image where the elements of the reference images are to be placed. Using the example above, where the base image is an image of a person standing in a field, with mountains in the background and clouds in the sky, a first reference image with some trees and a second reference image of a brand-aligned airplane, a first layout mask can indicate where, in the field of the base image, the trees are to be placed and a second layout mask can indicate where, in the sky of the base image, the airplane is to be placed.

In some aspects, layout masks are approximate, giving only rough locations within the base image to place the reference image elements. In some aspects, layout masks are more detailed, giving exact or near-exact location within the base image to place the reference image elements. In some aspects, a layout mask is the same size and/or shape as the reference image element so that, for example, a layout mask for the brand-aligned airplane is the same size and/or shape as the airplane. In some aspects, a layout mask differs in size and/or shape so that, for example, a layout mask for the brand-aligned airplane is merely a rectangle, or a circle, or some other such shape. In some aspects, a reference image has a corresponding layout mask to place a single element (e.g., to place a reference image element at a single location). In some aspects, a reference image has a corresponding layout mask to place multiple elements (e.g., to place a reference image element at multiple locations). In some aspects, layout masks are manually generated (e.g., by drawing on the base image or by specifying a location in the base image). In some aspects, layout masks are automatically generated (e.g., using software).

In accordance with aspects of the technology described herein, the output image is then generated using generative AI models. Given the base image, the reference images, and the layout masks, an image generation model generates the new brand-aligned image that incorporates the style and structure of the reference images into the base image. The layout masks enable fine-grained layout (e.g., precise placement) of the reference image elements by the image generation model using inpainting of the reference image elements into the base image. In some aspects, the image generation model is an untrained model (e.g., is a general purpose image generation model that is not specifically trained to perform such inpainting of brand-aligned content). In some aspects, the image generation model uses shared self-attention in a single forward pass to perform such inpainting. As used herein, inpainting is the process whereby a generative model generates foreground elements (e.g., the reference image elements) into the base image against the background. In some aspects, the image generation model also uses shared self-attention in a single forward pass to perform outpainting. As used herein, outpainting is the process whereby a generative model generates background elements while preserving some elements of the base image and adding the elements of the reference images (e.g., via inpainting). As may be contemplated, the distinction between inpainting and outpainting as used herein is merely for convenience as, in general, a generative model does not distinguish between the two when generating an image and both can be performed using the same generational model. In some aspects, outpainting can be used to generate variants of a brand-aligned image (e.g., with different backgrounds but the same base image and reference image content).

Advantageously, aspects of the technology described herein provide a number of improvements over existing technologies. For example, fine-grained selection of elements from reference images preserves the style and structure of the reference image elements during image generation so that, subtle elements of brand-aligned content are preserved when generating variant images. Aspects of the technology described herein also enable precise layout control so that elements from reference images can be generated in precise locations during image generation so that brand-aligned image elements from reference images are correctly placed when generating reference images. Additionally, as described above, this fine-grained selection and precise layout avoids costly regeneration of generated images, thereby more efficiently using computing resources by avoiding such regeneration.

As may be contemplated, although the technology described herein is described in terms of “branding” “brand-aligned content,” and marketing, the technology described herein can be used in any image generation process where fine-grained selection of image elements from reference images is required so as to preserve style and structure of those elements. For example, a precise technical drawing that is to be used as an element in automatic image generation using a generative AI model could have its style and structure preserved using the systems and methods described herein. Similarly, the technology described herein can be used in any image generation process where precise layout control is required again where, for example, the relative placement of elements is crucial to understanding the resulting generated image.

### Example System and Methods for Performing Image Generation

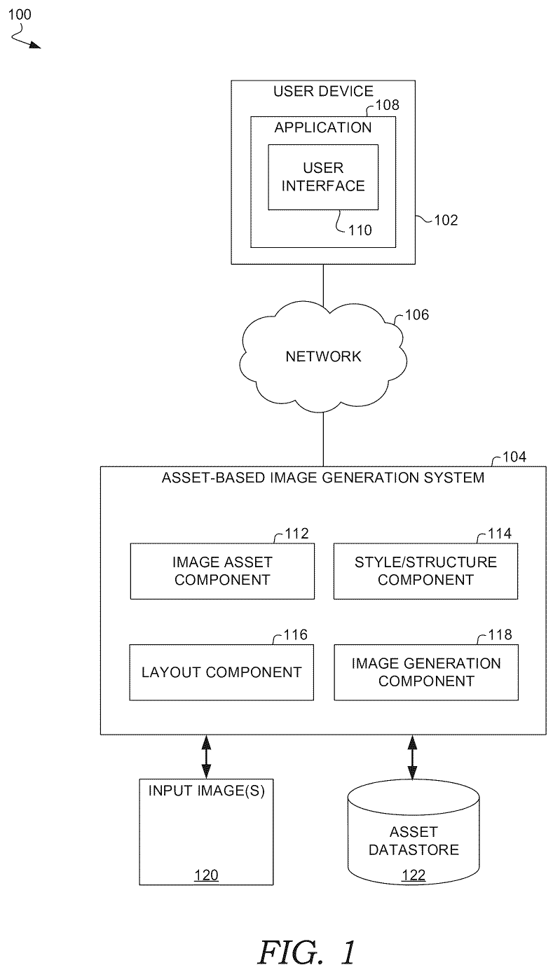

With reference now to the drawings, FIG. 1 is a block diagram illustrating an exemplary system 100 for performing multi-image based fine-grained image generation, in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

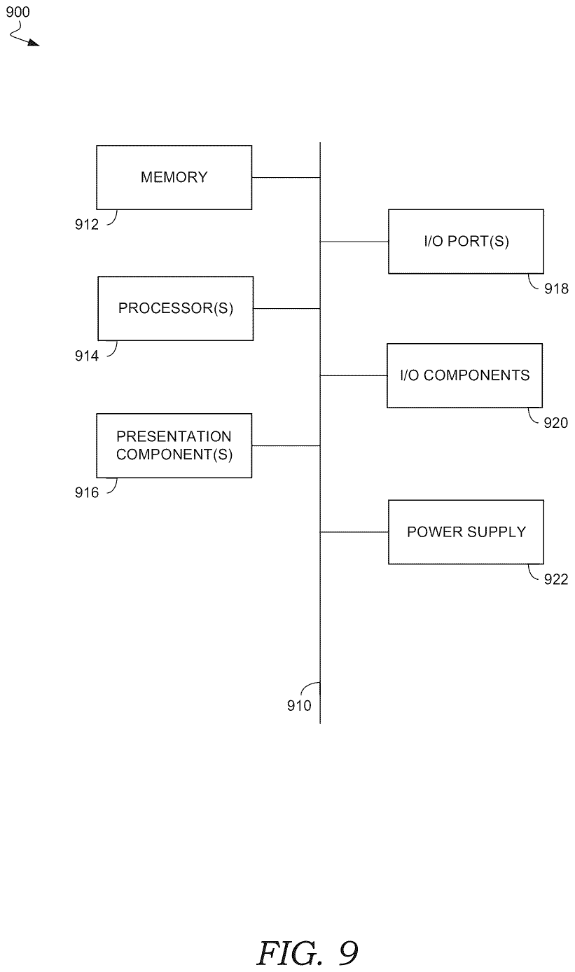

The system illustrated in block diagram 100 is an example of a suitable architecture for implementing certain aspects of the present disclosure. Among other components not shown, the system illustrated in block diagram 100 includes a user device 102 and an asset-based image generation system 104. Each of the user device 102 and the asset-based image generation system 104 shown in FIG. 1 can comprise one or more computer devices, such as the computing device 900 of FIG. 9, described below. As shown in FIG. 1, the user device 102 and the asset-based image generation system 104 can communicate via a network 106, which may include, without limitation, one or more local area networks (LANs) and/or wide area networks (WANs). Such networking environments are commonplace in offices, enterprise-wide computer networks, intranets, and the Internet. It should be understood that any number of user devices and servers may be employed within the system illustrated in block diagram 100 within the scope of the present technology. Each device or server may comprise a single device or multiple devices cooperating in a distributed environment. For instance, the asset-based image generation system 104 may be provided by multiple server devices collectively providing the functionality of the asset-based image generation system 104, as described herein. Additionally, other components not shown may also be included within the environment.

The user device 102 can be a client device on the client-side of the operating environment illustrated in block diagram 100, while the asset-based image generation system 104 can be on the server-side of the operating environment illustrated in block diagram 100. The asset-based image generation system 104 can comprise server-side software designed to work in conjunction with client-side software on the user device 102 so as to implement any combination of the features and functionalities discussed in the present disclosure. For example, the user device 102 can include an application 108 for interacting with the asset-based image generation system 104. The application 108 can be, for instance, a web browser or a dedicated application for providing functions, such as those described herein. This division of an operating environment illustrated in block diagram 100 is provided to illustrate one example of a suitable environment. There is no requirement for each implementation that any combination of the user device 102 and the asset-based image generation system 104 remain as separate entities. While the operating environment illustrated in block diagram 100 illustrates a configuration in a networked environment with a separate user device 102 and asset-based image generation system 104, it should be understood that other configurations can be employed in which aspects of the various components are combined. For instance, in some aspects, aspects of the asset-based image generation system 104 can be implemented in part or in whole by the user device 102.

In some configurations, the application 108 can comprise a user interface 110. In some configurations, the user interface 110 provides one or more user interfaces to a user of a device, such as the user device 102 for interacting with the asset-based image generation system 104. In some instances, the user interface 110 can be presented on the user device 102 via the application 108, which can be a web browser or a dedicated application for interacting with the asset-based image generation system 104. For instance, the user interface 110 can provide user interfaces for, among other things, receiving input from a user and providing responses to the user. It should be noted that, while the user interface 110 is shown as an element of application 108, in some embodiments, the asset-based image generation system 104 further includes a user interface component (not shown in FIG. 1) that provides one or more user interfaces for interacting with the asset-based image generation system 104. In some aspects, not shown in FIG. 1, a user interface component provides one or more user interfaces to a user device, such as the user device 102 via the application 108.

The user device 102 may comprise any type of computing device capable of use by a user. For example, in one aspect, a user device may be the type of computing device 900 described in relation to FIG. 9 herein. By way of example and not limitation, the user device 102 may be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device. A user may be associated with the user device 102 and may interact with the asset-based image generation system 104 via the user device 102.

In some configurations, the asset-based image generation system 104 may be implemented, at least in part, using artificial intelligence models that generate responses to user queries through natural language interaction. In such instances, the asset-based image generation system 104 can use artificial intelligence and machine learning algorithms to understand user queries, interpret context, and generate responses by accessing relevant information from various sources. In at least one embodiment, the asset-based image generation system 104 uses generative models such as those described herein to understand user queries, interpret context, and generate asset-based images using systems, methods, operations, and techniques such as those described herein.

As shown in FIG. 1, the asset-based image generation system 104 comprises an image asset component 112, a style/structure component 114, a layout component 116, and/or an image generation component 118. The modules/components of the asset-based image generation system 104 may be in addition to other components that provide further additional functions beyond the features described herein. The asset-based image generation system 104 can be implemented using one or more server devices, one or more platforms with corresponding application programming interfaces, cloud infrastructure, and the like. While the asset-based image generation system 104 is shown as separate from the user device 102 in the configuration of FIG. 1, it should be understood that in other configurations, some or all of the functions of the asset-based image generation system 104 can be provided on the user device 102. Additionally, in some configurations, one or more of the components of the asset-based image generation system 104 shown in FIG. 1 (e.g., the image asset component 112, the style/structure component 114, the layout component 116, and/or the image generation component 118) can be provided by the user device 102 and/or another device not shown in FIG. 1. In some configurations, the components of the asset-based image generation system 104 can be provided by a single entity or by multiple entities.

In some aspects, the functions performed by the components of asset-based image generation system 104 are associated with one or more applications, services, or routines. In particular, such applications, services, or routines may operate on one or more user devices and servers, may be distributed across one or more user devices and servers, or may be implemented in the cloud. Moreover, in some aspects, these components of the asset-based image generation system 104 may be distributed across a network, including one or more servers and client devices, in the cloud, and/or may reside on a user device. Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in the example system illustrated in block diagram 100, it is contemplated that in some aspects, functionality of these components can be shared or distributed across other components.

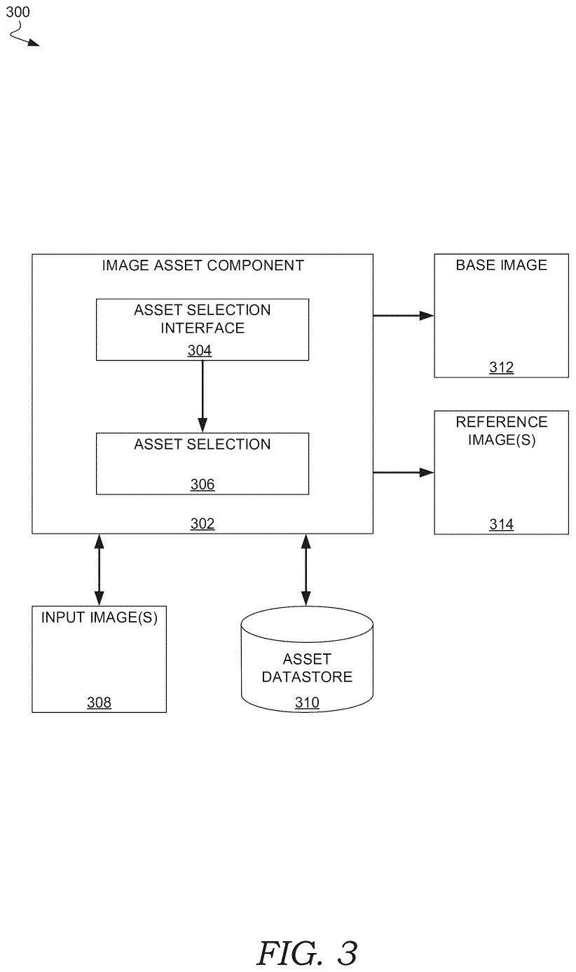

Given an input from a user device (e.g., user device 102) to perform multi-image based fine-grained image generation, the asset-based image generation system 104 uses the image asset component 112 to select and/or generate a base image, and to select and/or generate one or more reference images. In come configurations, the image asset component 112 receives, as input, one or more input images 120 that comprise a base image and one or more reference images. In some configurations, input images 120 are provided as input from a user of user device 102, using user interface 110 of application 108. In some configurations, input images 120 are obtained from an asset datastore 122, which may, for example, contain brand-aligned images. In some configurations, asset datastore 122 is a structured datastore that includes image data and/or image metadata stored so that such data and/or metadata can be retrieved or otherwise accessed by user device 102, using user interface 110 of application 108. In some configurations, asset datastore 122 can be retrieved or otherwise accessed by components of asset-based image generation system 104. Further details of the image asset component 112 are described below, in connection with FIG. 3.

Given an input from a user device (e.g., user device 102) to perform multi-image based fine-grained image generation, the asset-based image generation system 104 uses the style/structure component 114 to determine the style and structure of the elements from the reference images. In some aspects, the style/structure component 114 uses a segment anything model (SAM) to locate the elements in the reference images so that, for example, a prompt of “generate an image of a person standing in a field with mountains in the background and clouds in the sky and add these trees and this airplane from these reference images” uses a SAM to locate the airplane in the reference image. In some aspects, a segment anything model is an AI model that can produce object masks from input prompts (e.g., “locate the airplane in this image”).

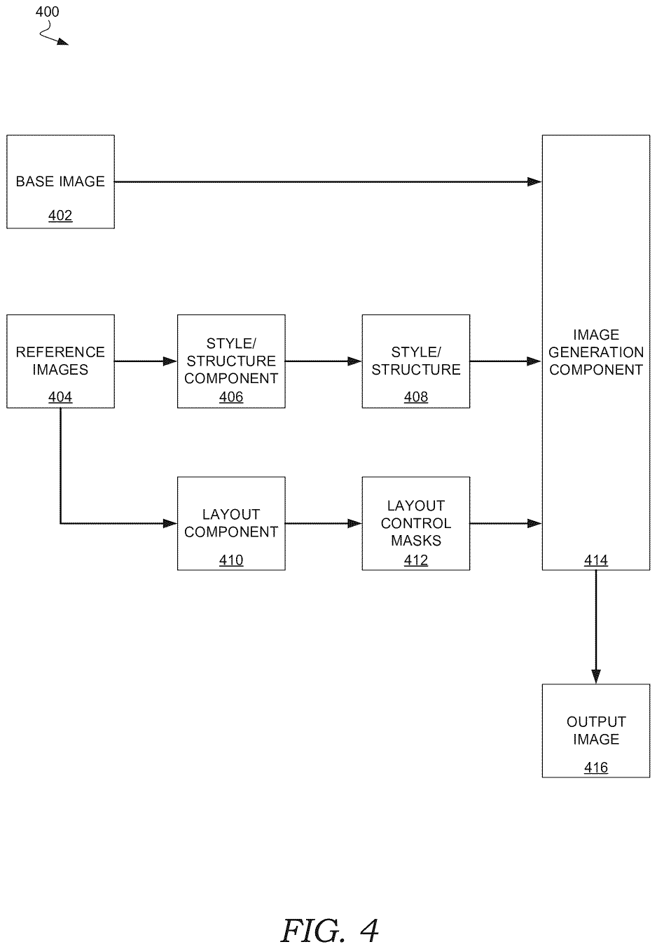

In some aspects, locating the brand-aligned elements in the reference images enables the style/structure component 114 to preserve the style and/or structure of those brand-aligned elements (e.g., to preserve the colors, shapes, drawing style, etc. of that element). Further details of the style/structure component 114 are described below, in connection with FIG. 4.

Given an input from a user device (e.g., user device 102) to perform multi-image based fine-grained image generation, the asset-based image generation system 104 uses the layout component 116 to generate one or more layout masks within the base image to guide the placement of the reference image elements within the base image. Using the example above, where the base image is an image of a person standing in a field, with mountains in the background and clouds in the sky, a first reference image with some trees and a second reference image of a brand-aligned airplane, a first layout mask can indicate where, in the field of the base image, the trees are to be placed and a second layout mask can indicate where, in the sky of the base image, the airplane is to be placed.

As described above, in some aspects, layout masks are approximate, giving only rough locations within the base image to place the reference image elements. In other aspects, layout masks are more detailed, giving exact or near-exact location within the base image to place the reference image elements. In some aspects, each reference image has a corresponding layout mask so that, for two reference images, there are two layout masks. In some aspects, layout masks are manually generated (e.g., by drawing on the base image or by specifying a location in the base image). In some aspects, layout masks are automatically generated (e.g., using software). Further details of the layout component 116 are described below, in connection with FIG. 4.

Given an input from a user device (e.g., user device 102) to perform multi-image based fine-grained image generation, the asset-based image generation system 104 uses the image generation component 118 to generate a new brand-aligned image that incorporates the style and structure of the reference images into the base image, as described herein. In some aspects, the image generation component 118 uses a generative AI model, as described herein.

In some aspects, a generative AI model comprises a multi-modal language model that includes a set of statistical or probabilistic functions to perform Natural Language Processing (NLP) in order to understand and learn prompts used to generate images. In some aspects, a generative AI model can be a model that is trained to receive text prompts and generate images based on those prompts. Such generative AI models can use previously trained large language models (LLM) to process image generation prompts and can be trained to generate images based on a large corpus of images. In some configurations, a language model can receive image input (e.g., a source image) and provide a description of the image. In some configurations, an image generation model can receive text input and can generate an image corresponding to that text input. Accordingly, such models can comprise a deep neural network that is very large (billions to hundreds of billions of parameters) and understands, processes, and produces human natural language by being trained on massive amounts of text.

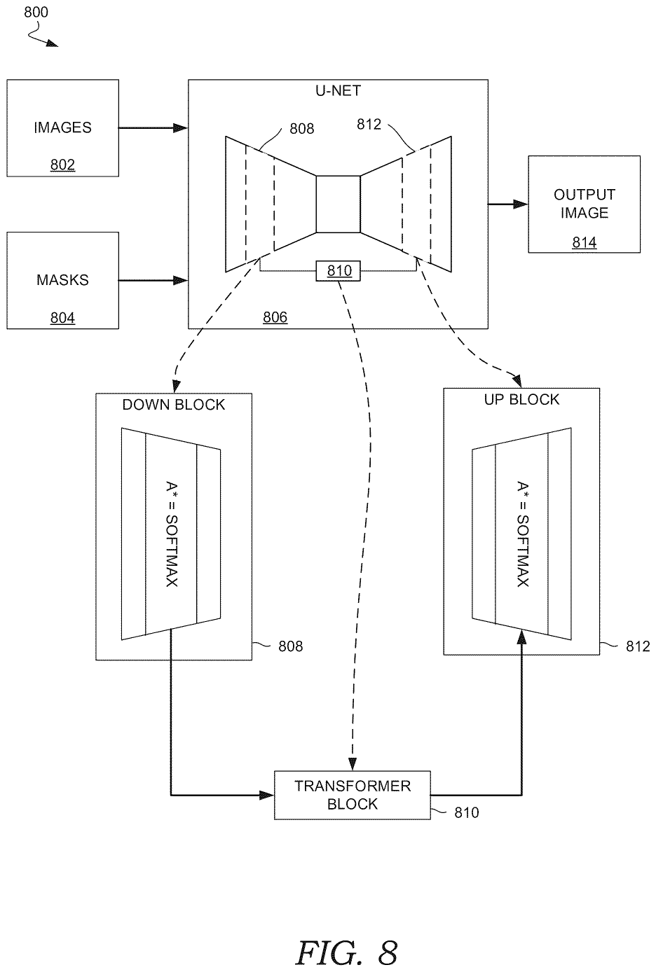

In some aspects, the image generation model is an untrained model (e.g., is a general purpose image generation model that is not specifically trained to perform image generation using brand-aligned content). In some aspects, the image generation model uses shared self-attention in a single forward pass to perform image generation. In some aspects, the image generation component 118 uses a U-Net, which is a convolutional neural network architecture of a diffusion model used for image generation by performing iterative image denoising through successive passes through downsampling and upsampling, as illustrated in connection with FIGS. 8 and 9. Further details of the image generation component 118 are described below, in connection with FIGS. 4, 8, and 9.

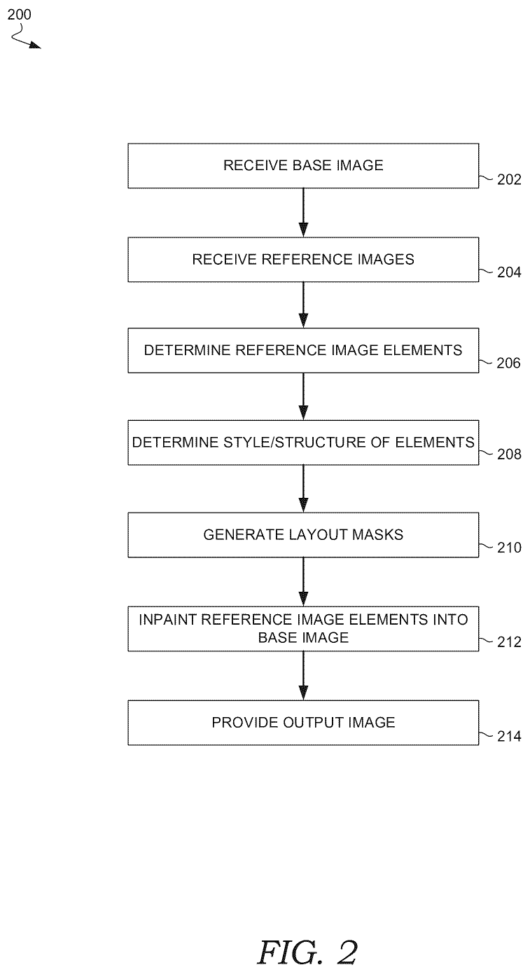

FIG. 2 is a flow diagram 200 showing an example process for performing multi-image based fine-grained image generation, in accordance with some implementations of the present disclosure. The process (or method) illustrated in FIG. 2 can be performed by, for instance, the asset-based image generation system 104 described herein at least in connection with FIG. 1. Each block of the method illustrated in FIG. 2 and any other methods described herein comprises a computing process performed using any combination of hardware, firmware, and/or software. For instance, various functions can be carried out by a processor executing instructions stored in memory. The method or methods can also be embodied as computer-usable instructions stored on computer storage media. The methods can be provided by a standalone application, a service or hosted service (standalone or in combination with another hosted service), a plug-in to another product, or other such applications, services, products, or plug-ins.

At block 202, a processor performing the process illustrated in FIG. 2 performs operations to receive a base image. In some aspects, the base image is a source image that is to be used as a basis for one or more variant images to be generated using the process illustrated in FIG. 2. For example, a base image may be a general image that will have brand-aligned content added so that the base image conforms to requirements of a marketing campaign. In some aspects, a base image is specified by a user of the process illustrated in FIG. 2 using, for example, an application such as application 108. In some aspects, a base image is obtained from an asset datastore 122. In some aspects, after block 202, the process illustrated in FIG. 2 continues at block 204.

At block 204, a processor performing the process illustrated in FIG. 2 performs operations to receive one or more reference images. In some aspects, the reference images include brand-aligned content, as described here (e.g., content with style and/or structure that conforms to a particular brand). In some aspects, reference images are specified by a user using, for example, an application such as application 108. In some aspects, reference images are obtained from an asset datastore 122. In some aspects, after block 204, the process illustrated in FIG. 2 continues at block 206.

At block 206, a processor performing the process illustrated in FIG. 2 performs operations to determine elements from the one or more reference images received at block 204. In some aspects, those reference image elements are determined using a text-to-image model that uses natural language processing to process a description of a desired output image and to generate the output image. For example, reference image elements can be determined using a segment anything model (SAM), as described herein. In some aspects, after block 206, the process illustrated in FIG. 2 continues at block 208.

At block 208, a processor performing the process illustrated in FIG. 2 performs operations to determine the style and structure of the elements determined at block 206 (e.g., from the reference images received at block 204). In some aspects, the style and structure data includes both style elements such as colors, shapes, color palettes, drawing style, etc. as well as structure elements such as proportions, placement of elements, etc. In some aspects, after block 208, the process illustrated in FIG. 2 continues at block 210.

At block 210, a processor performing the process illustrated in FIG. 2 performs operations to generate layout masks to layout elements determined at block 206 within the base image received at block 202. In some aspects, layout masks are automatically generated using software. In some aspects, layout masks are manually drawn or specified. In some aspects, layout masks are approximate. In some aspects, layout masks are exact. In general, a layout mask is to specify where, in an output image, the elements of the reference image are to be placed when an output image is generated using a generative AI model. In some aspects, after block 210, the process illustrated in FIG. 2 continues at block 212.

At block 212, a processor performing the process illustrated in FIG. 2 performs operations to generate an image by inpainting reference image elements determined at block 206 into the base image received at block 202 using the layout masks generated at block 210. In some aspects, the inpainting is performed using a generative AI model (e.g., for image generation) using systems and methods described herein in FIGS. 4-8. In some aspects, after block 212, the process illustrated in FIG. 2 continues at block 214.

At block 214, a processor performing the process illustrated in FIG. 2 performs operations to provide an output image (e.g., the image generated at block 212). In some aspects, the output image is provided to a user interface such as user interface 110. In some aspects, an output image is stored in an asset datastore such as asset datastore 122. In some aspects, after block 214, the process illustrated in FIG. 2 terminates. In some aspects, not shown in FIG. 2, after block 214, the process illustrated in FIG. 2 continues at block 202, to receive another base image. In some aspects, not shown in FIG. 2, after block 214, the process illustrated in FIG. 2 continues at block 204, to receive more reference images to be used with the previously received base image.

Although not illustrated in FIG. 2, in some configurations, the operations of the process illustrated in FIG. 2 are performed in a different order than that described. In some configurations, where operations can be performed in a different order, some of the operations can be performed in parallel by a plurality of devices such as those described herein using a plurality of threads. As may be contemplated, other orders in which to perform the operations illustrated in flow diagram 200 may be considered as within the scope of the present disclosure.

FIG. 3 is a block diagram 300 showing an example image asset component, in accordance with some implementations of the present disclosure. In some aspects, an image asset component 302 provides an asset selection interface 304 to perform asset selection 306. In some aspects, image asset component 302 is an image asset component such as image asset component 112, described in connection with FIG. 1. In some aspects, asset selection interface 304 is an element of user interface 110, also described in connection with FIG. 1. In some aspects, asset selection 306 selects assets from input images 308. In some aspects, asset selection 306 selects assets from asset datastore 310. In some aspects, asset datastore 310 is an asset datastore such as asset datastore 122 that contains brand-aligned reference images, as described herein.

In some aspects, a prompt such as “generate an image of a person standing in a field with mountains in the background and clouds in the sky and add trees and an airplane,” provided as input to the image asset component 302 would cause the image asset component 302 to perform asset selection 306 to determine the base image 312 and identify appropriate reference images 314 from either the input images 308, the asset datastore 310, or a combination of these.

In some aspects, asset selection 306 receives a base image (e.g., one of input images 308 or an image from asset datastore 310), which comprises an image of a person standing in a field with mountains in the background and clouds in the sky. In such aspects, a prompt may be “generate an image using this base image and add trees and an airplane.” With this prompt, the base image 312 is provided and the reference images 314 are identified from either the input images 308, the asset datastore 310, or a combination of these.

In some aspects, asset selection 306 receives the base image. For example, the base image may include an image of a person standing in a field with mountains in the background and clouds in the sky. The asset selection 306 may also receive one or more reference images which contain the brand-aligned image elements (e.g., the trees and the airplane). In such aspects, a prompt may be “generate an image using this base image and add the trees from the first reference image and the airplane from the second reference image.” With this prompt, the base image 312 is provided and the reference images 314 are also provided from either the input images 308, the asset datastore 310, or a combination of these

FIG. 4 is a block diagram 400 showing an exemplary data flow of a system used to perform multi-image based fine-grained image generation, in accordance with some implementations of the present disclosure. In some aspects, an asset selection component such as asset selection component 302 provides a base image 402 and one or more reference images 404 (e.g., as described above in connection with FIG. 3).

In some aspects, a style/structure component 406 generates the style/structure 408 of the reference images 404. In some aspects, the style/structure component 406 (which is a style/structure component such as style/structure component 114) generate the style/structure 408 of the reference images 404 by locating the reference image elements (e.g., using a segment anything model) and determining style and/or structure from those located elements.

In some aspects, a layout component 410 generates the layout control masks 412 of the reference images 404. In some aspects, the layout component 410 (which is a layout component such as layout component 116) generates the layout control masks 412 of the reference images 404 as described above (e.g., using rough or exact masks corresponding to the desired placement of the reference image elements within the base image.

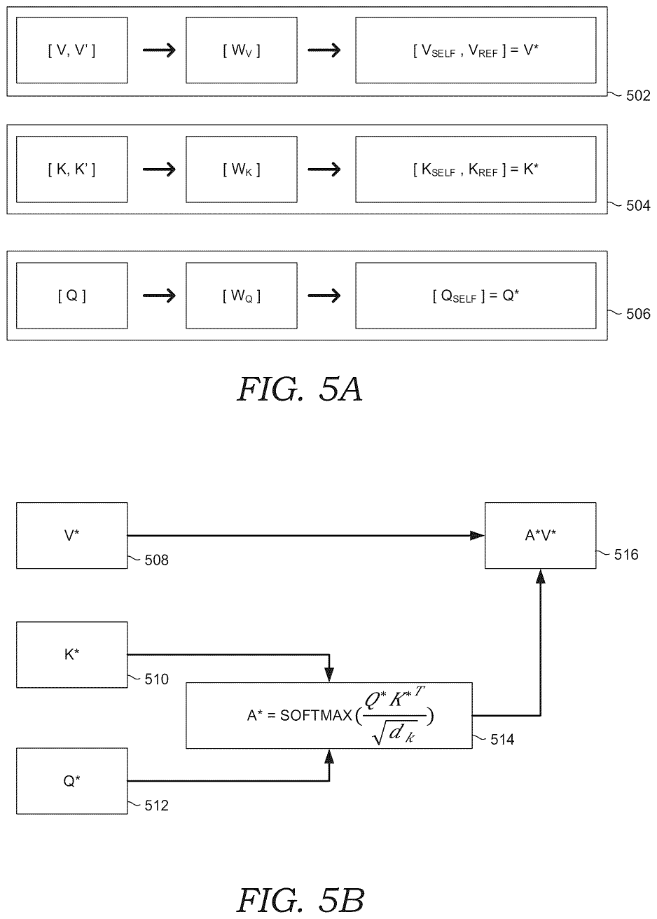

In some aspects, the base image 402, the style/structure 408, and/or the layout control masks 412 are provided to an image generation component 414 which uses those elements to generate an output image 416 using image generation, as described herein at least in connection with FIGS. 5-8. In some aspects, image generation component 414 is an image generation component such as image generation component 118.

FIGS. 5A and 5B illustrate an exemplary shared self-attention computation, in accordance with some implementations of the present disclosure. The self-attention computation illustrated in FIG. 5 is for a general self-attention layer of a diffusion U-Net which has self-attention layers in every block (downblock and upblock) to attend to itself to generate a coherent image. In some aspects, keys and values of the self-attention features of a reference image are computed and cached while denoising a noised version of the reference image.

In some aspects, diffusion sampling (e.g., by a U-Net) proceeds in timesteps. At timestep t of diffusion sampling, K(t) is the self-image intermediate key and V(t) is the self-image value features, where the self-image is the input noisy latents propagated through the network. Given a reference image R, a noised version of the reference image Rat timestep t is computed using a closed form formula: R(t)=add_noise(R,t) and R(t) can be denoised using a single timestep forward pass of the U-Net diffusion model: R(t−1)=eps_forward(R(t−1)). During this forward pass, the keys and values of the reference image, K′(t) and V′(t) are stored and, during conditional generation, the stored keys and values, K′ and V′ are appended to the self-image keys and values, K and V, as shown in FIG. 5A.

Values 502 shows self-image value V and appended stored value V′ multiplied by a weighting matrix W_{V} to generate V*, which comprises [V_{SELF}, V_{REF}]. Keys 504 shows self-image key K and appended stored key K′ multiplied by a weighting matrix W_{K} to generate K*, which comprises [K_{SELF}, K_{REF}]. Query features 506 shows query features Q of the self image which is multiplied by a weighting matrix W_{Q} to generate Q*, which comprises [Q_{SELF}]. In some aspects, query features 506 are the input latents to the transformer. In some aspects, weighting matrices W_{V}, W_{K}, and W_{Q} are learned during training of the generative AI model.

FIG. 5B illustrates the computation of the self-attentions where the attention similarity A* 514 is computed using K* 510 and Q* 512 (e.g., as described above) using equation:

$${A}^{*} = SOFTMAX ( \frac{{Q}^{*} {K}^{* T}}{\sqrt{{d}_{k}}} ) \qquad ( 1 )$$

where \sqrt{dₖ} is the square root of the number of items used to decide attention (the number of items in the key vector) and SOFTMAX is a normalized exponential function that, in this instance, converts the vector Q*K*^{T} to a probability distribution of possible outcomes. In some aspects, A* 514 is multiplied by V* 508 to compute the self-attenuation A*V* 516.

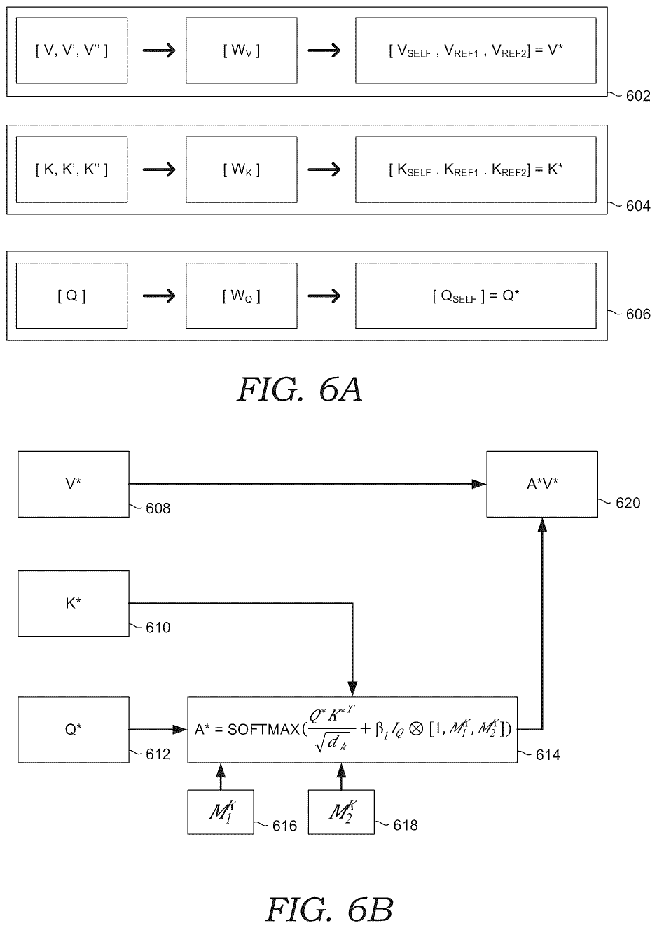

FIGS. 6A and 6B illustrate an exemplary shared self-attention computation using masks for fine-grained shared self-attention, in accordance with some implementations of the present disclosure. The self-attention computation illustrated in FIG. 6 is for a fine-grained self-attention that enables conditioning on the fine-grained aspects of multiple reference images. In some aspects, keys and values of self-attention features of a multiple reference images are computed and cached while denoising a noised version of the reference images. In the example illustrated in FIGS. 6A and 6B, two reference images are used but, as may be contemplated, the process illustrated herein can be extended to any number of reference images.

In some aspects, diffusion sampling (e.g., by a U-Net) proceeds in timesteps as described above in connection with FIG. 5A. In FIG. 6A, during the forward pass, the keys and values of the first reference image, K′(t) and V′(t) are stored, the keys and values of the second reference image, K″(t) and V″(t) are also stored and, during conditional generation, the stored keys K′ and K″ are appended to the self-image keys K and the stored values V′ and V″ are appended to the self-image values V.

Values 602 shows self-image value V and appended stored values V′ and V″ multiplied by a weighting matrix W_{V} to generate V*, which comprises [V_{SELF}, V_{REF1}, V_{REF2}]. Keys 604 shows self-image key K and appended stored keys K′ and K″ multiplied by a weighting matrix W_{K} to generate K*, which comprises [K_{SELF}, K_{REF1}, K_{REF2}]. Query features 606 shows query features Q of the self image which is multiplied by a weighting matrix W_{Q} to generate Q*, which comprises [Q_{SELF}]. Query features 606 are as described above and, in some aspects, weighting matrices W_{V}, W_{K}, and W_{Q} are learned during training of the generative AI model.

FIG. 6B illustrates the computation of the self-attentions where the attention similarity A* 614 is computed using K* 610 and Q* 612 (e.g., as described above) using equation:

$${A}^{*} = SOFTMAX ( \frac{{Q}^{*} {K}^{* T}}{\sqrt{{d}_{k}}} + {β}_{1} {I}_{Q} ⊗ [ 1 , {M}_{1}^{K} , {M}_{2}^{K} ] ) \qquad ( 2 )$$

where \sqrt{dₖ} and SOFTMAX are as described above in connection with FIG. 5B. In equation (2), β₁ is a tunable hyperparameter of the generative AI model that adjust the scaling of the conditioning, I_{Q} is an identity matrix that is the same size as the query matrix Q,

$${M}_{1}^{K}$$

616 is a reference mask for the first reference image,

$${M}_{2}^{K}$$

618 is a reference mask for the second reference image, and ⊗ is an outer product of the matrix β₁I_{Q} with the vector

$$[ {1}_{1} , {M}_{1}^{K} , {M}_{2}^{K} ] .$$

In some aspects, A* 614 is multiplied by V* 608 to compute the self-attenuation A*V* 620.

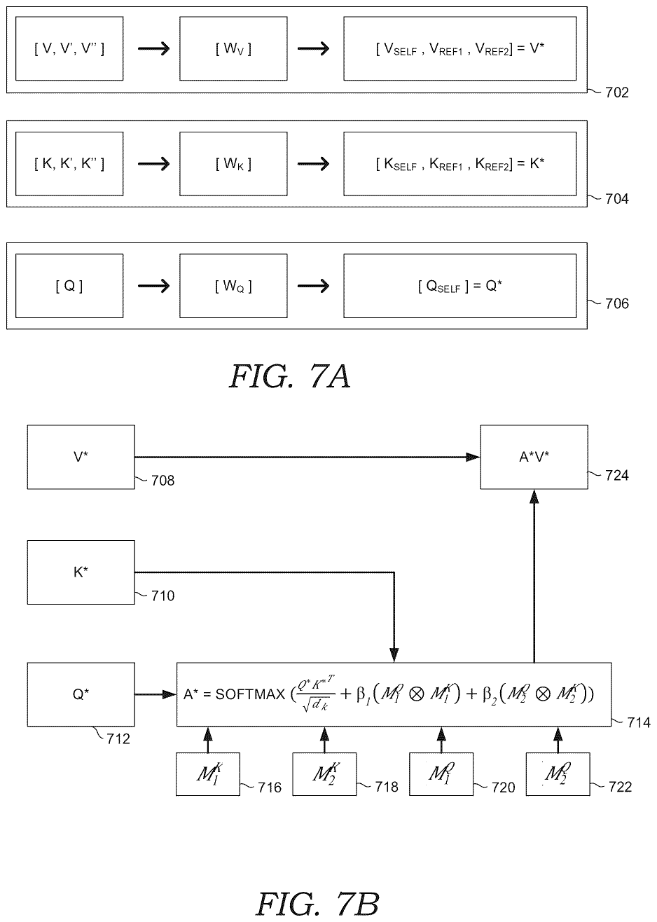

FIGS. 7A and 7B illustrate an exemplary shared self-attention computation using layout masks and fine-grained shared self-attention, in accordance with some implementations of the present disclosure. The self-attention computation illustrated in FIG. 7 is for a fine-grained self-attention with layout masks that enables conditioning on the fine-grained aspects of multiple reference images. In some aspects, keys and values of self-attention features of a multiple reference images are computed and cached while denoising a noised version of the reference images. As with the example illustrated in FIGS. 6A and 6B, in the example illustrated in FIGS. 7A and 7B, two reference images are used but, as may be contemplated, the process illustrated herein can be extended to any number of reference images.

In some aspects, diffusion sampling (e.g., by a U-Net) proceeds in timesteps as described above in connection with FIG. 5A. In FIG. 7A, during the forward pass, the keys and values of the first reference image, K′(t) and V′(t) are stored, the keys and values of the second reference image, K″(t) and V″(t) are also stored and, during conditional generation, the stored keys K′ and K″ are appended to the self-image keys K and the stored values V′ and V″ are appended to the self-image values V.

Values 702 shows self-image value V and appended stored values V′ and V″ multiplied by a weighting matrix W_{V} to generate V*, which comprises [V_{SELF}, V_{REF1}, V_{REF2}]. Keys 704 shows self-image key K and appended stored keys K′ and K″ multiplied by a weighting matrix W_{K} to generate K*, which comprises [K_{SELF}, K_{REF1}, K_{REF2}]. Query features 706 shows query features Q of the self image which is multiplied by a weighting matrix W_{Q} to generate Q*, which comprises [Q_{SELF}]. The computations shown in FIG. 7A are the same as those shown in FIG. 6A.

FIG. 7B illustrates the computation of the self-attentions where the attention similarity A* 714 is computed using K* 710 and Q* 712 (e.g., as described above) using equation:

$${A}^{*} = SOFTMAX ( \frac{{Q}^{*} {K}^{* T}}{\sqrt{{d}_{k}}} + {β}_{1} ( {M}_{1}^{Q} ⊗ {M}_{1}^{K} ) + {β}_{2} ( {M}_{2}^{Q} ⊗ {M}_{2}^{K} ) ) \qquad ( 3 )$$

where \sqrt{dₖ} and SOFTMAX are as described above in connection with FIG. 5B. In equation (3), β₁ and β₂ are a tunable hyperparameters of the generative AI model that adjust the scaling of the conditioning of each of the masks,

$${M}_{1}^{K}$$

716 is a reference mask for the first reference image,

$${M}_{2}^{K}$$

718 is a reference mask for the second reference image,

$${M}_{1}^{Q}$$

720 is a query layout mask for the first reference image,

$${M}_{2}^{Q}$$

722 is a query layout mask for the second reference image, and ⊗ is an outer product operator. In some aspects, A* 714 is multiplied by V* 708 to compute the self-attenuation A*V* 724. In some aspects, self-attention A*V*724 is used in downblock 808 and/or upblock 812 of U-Net 806, described below in connection with FIG. 8.

FIG. 8 is a block diagram 800 showing an exemplary architecture of a system used to perform multi-image based fine-grained image generation, in accordance with some implementations of the present disclosure. In some aspects, image generation uses a U-Net 806 to generate an output image 814 using one or more input images 802 and one or more masks 804. In some aspects, input images 802 includes a base image and one or more reference images, as described herein. In some aspects, masks 804 includes reference masks, layout masks, query layout masks, and/or other such masks. In some aspects, masks 804 includes one or more outpainting masks which is used by U-Net 802 to generate background elements of output image 814.

In the example illustrated in FIG. 8, U-Net 808 includes one or more down blocks 808 (e.g., downsampling blocks), one or more up blocks 812 (e.g., upsampling blocks), and one or more transformer blocks 810. In some aspects, not shown in FIG. 8, U-Net 808 also has one or other blocks such as convolution blocks that are used by U-Net 806 to generate an output image 814 using images 802 and/or masks 804.

In some aspects, down block 808 performs one or more operations before computing A* (e.g., using equation (3), above) and/or one or more operations after computing A*. Similarly, in some aspects, up block 812 performs one or more operations before computing A* (e.g., using equation (3), above) and/or one or more operations after computing A*. In some aspects, the results of computing A* by down block 808 are transformed by transform block 810 before up block 812 computes A*.

### Exemplary Operating Environment

Having described implementations of the present disclosure, an exemplary operating environment in which embodiments of the present technology can be implemented is described below in order to provide a general context for various aspects of the present disclosure. Referring initially to FIG. 9 in particular, an exemplary operating environment for implementing embodiments of the present technology is shown and designated generally as computing device 900. Computing device 900 is but one example of a suitable computing environment and is not intended to suggest any limitation as to the scope of use or functionality of the technology. Neither should the computing device 900 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 9, computing device 900 includes bus 910 that directly or indirectly couples the following devices: memory 912, one or more processors 914, one or more presentation components 916, input/output (I/O) ports 918, input/output components 920, and illustrative power supply 922. Bus 910 represents what can be one or more busses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 9 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 9 and reference to “computing device.”

Computing device 900 typically includes a variety of computer-readable media. Computer-readable media can be any available media that can be accessed by computing device 900 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 900. The terms “computer storage media” and “computer storage medium” do not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 912 includes computer storage media in the form of volatile and/or nonvolatile memory. The memory can be removable, non-removable, or a combination thereof. Exemplary hardware devices include solid-state memory, hard drives, optical-disc drives, etc. Computing device 900 includes one or more processors that read data from various entities such as memory 912 or I/O components 920. Presentation component(s) 916 present data indications to a user or other device. Exemplary presentation components include a display device, speaker, printing component, vibrating component, etc.

I/O ports 918 allow computing device 900 to be logically coupled to other devices including I/O components 920, some of which can be built in. Illustrative components include a microphone, joystick, game pad, satellite dish, scanner, printer, wireless device, etc. The I/O components 920 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 900. The computing device 900 can be equipped with depth cameras, such as, stereoscopic camera systems, infrared camera systems, RGB camera systems, and combinations of these for gesture detection and recognition. Additionally, the computing device 900 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising” and the word “accessing” comprises “receiving,” “referencing,” or “retrieving.” Further, the word “communicating” has the same broad meaning as the word “receiving” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations, the operations comprising:
receiving input data comprising a base image and one or more reference images;
determining one or more reference image elements from the one or more reference images;
generating, for each of the one or more reference image elements, style and structure data;
receiving layout masks indicating a location within the base image at which to place the one or more reference image elements;
generating, using a generative artificial intelligence model, an output image comprising at least a portion of the base image and the one or more reference image elements placed at locations in the base image determined based, at least in part, on the layout masks and using the style and structure data; and
providing a user interface presenting the output image.

2. The one or more computer storage media of claim 1, wherein the reference image elements are determined from the one or more reference images using a segment anything model (SAM).

3. The one or more computer storage media of claim 1, wherein at least one of the one or more reference images comprises brand-aligned content.

4. The one or more computer storage media of claim 1, wherein the layout masks are generated automatically from the one or more reference images.

5. The one or more computer storage media of claim 1, wherein the generative artificial intelligence model comprises a diffusion U-Net.

6. The one or more computer storage media of claim 1, wherein the one or more reference image elements are determined from the one or more reference images based, at least in part, on text descriptions of the one or more reference images.

7. The one or more computer storage media of claim 1, wherein the generative artificial intelligence model uses shared self-attention to generate the output image.

8. The one or more computer storage media of claim 7, wherein the shared self-attention comprises:
generating noised versions of the one or more reference images;
computing keys and values of self-attention features of the one or more reference images while denoising the noised versions;
caching the keys and values;
appending the cached keys and values to self-image keys and values; and
computing the self-attention using an attention similarity based, at least in part, on the appended cached keys and values and the self-image keys and values.

9. The one or more computer storage media of claim 7, wherein the shared self-attention is based, at least in part, on one or more reference masks.

10. The one or more computer storage media of claim 7, wherein the shared self-attention is based, at least in part, on one or more query layout masks.

11. A computer-implemented method comprising:
receiving, at an image asset component, input data comprising a base image and reference images;
determining, using the image asset component, reference image elements from the reference images;
generating, using a style/structure component, style and structure data for each of the reference image elements;
receiving, at a layout component, layout masks indicating a location within the base image at which to place the reference image elements; and
generating, using a generative artificial intelligence model of an image generation component, an output image comprising at least a portion of the base image and the one or more reference image elements placed at locations in the base image determined based, at least in part, on the layout masks and using the style and structure data.

12. The computer-implemented method of claim 11, wherein the reference image elements are determined from the reference images using a segment anything model (SAM) that uses text descriptions of the reference images.

13. The computer-implemented method of claim 11, wherein the generative artificial intelligence model uses shared self-attention to generate the output image.

14. The computer-implemented method of claim 13, wherein the shared self-attention is fine-grained self-attention that is based, at least in part, on one or more reference masks.

15. The computer-implemented method of claim 14, wherein the shared self-attention is fine-grained self-attention with layout control that is based, at least in part, on one or more query layout masks.

16. A computer system comprising:
one or more processors; and
one or more computer storage media storing computer-useable instructions that, when used by the one or more processors, causes the computer system to perform operations comprising:
obtaining input data comprising brand-aligned reference images;
determining reference image elements from the brand-aligned reference images;
generating, for the reference image elements, style and structure data;
receiving layout masks indicating a location within an output image at which to place the reference image elements; and
generating, using a generative artificial intelligence model, the output image comprising the one or more reference image elements placed at locations in the output image determined based, at least in part, on the layout masks and using the style and structure data.

17. The computer system of claim 16, wherein the reference image elements are determined from the brand-aligned reference images using an image segmentation model.

18. The computer system of claim 16, wherein the input data comprises a base image and the output image comprises at least a portion of the base image.

19. The computer system of claim 16, wherein the generative artificial intelligence model comprises a text-to-image model that receives a description of the output image and uses natural language processing to generate the output image.

20. The computer system of claim 16, wherein the generative artificial intelligence model uses fine-grained self-attention with layout control to generate the output image based, at least in part, on one or more reference masks and one or more query layout masks.
